(19) United States
(12) Patent Application Publication
(10) Pub. No.: US 2002/0147928 A1
(43) Pub. Date: Oct. 10, 2002

(54) Method of information dissemination in a network of end terminals

(75) Inventors: Anant Mahajan, Blair Athol (AU); Philip Moseley, Montague Farm (AU)

Correspondence Address: MOTOROLA, INC., 1303 EAST ALGONQUIN ROAD, IL01/3RD, SCHAUMBURG, IL, 60196

(73) Assignee: MOTOROLA, INC.

(21) Appl. No.: 09/829,769

(22) Filed: Apr. 10, 2001

(51) Int. Cl. H04L 9/00

(52) U.S. Cl. 713/201

(57) ABSTRACT

A method (20) of disseminating information by a first end terminal (6) in a network having a plurality of end terminals (6) is disclosed. The method (20) includes the first end terminal (6) receiving (22) information from an information source, validating (24) the information and storing (28) the validated information. The method (20) also includes automatically forwarding (34) the validated information to a second end terminal (6) of the plurality of end terminals (6) over a communication channel established between the first and the second end terminals (6). The communication channel is established for a purpose separate from forwarding said validated information.

### FIELD OF THE INVENTION

The present invention relates, in general, to a method of disseminating information in a network of end terminals, and more particularly, to a method of disseminating information via an electronic word of mouth method amongst the end terminals.

### BACKGROUND OF THE INVENTION

With the increasing popularity of the Internet and the World Wide Web, it has become common for merchants to set up Web sites for marketing and selling goods. Via such a Web site, consumers can access and place orders from an online catalog that includes a large number of goods. Such a Web site however suffers from a disadvantage of not being able to efficiently attract potential consumers to the Web site.

One way of attracting consumers has been to market the Web site through television, newspaper and Internet advertisements. However, advertising a site using conventional methods can be expensive, and can consume significant human resources. In addition, it is often difficult or impossible to evaluate the effectiveness of a given advertisement.

Another method to further the reach of an advertisement is to have associates create Web sites containing links to a merchant's web site. Although there are more chances that the merchant's advertisement can be seen, a consumer still has to log onto one of the associate sites to see the advertisement. The reach of the advertisement though improved, is therefore still limited. Attempts have been made to further improve the reach of an advertisement. U.S. Pat. No. 6,151,585 discloses a method of identifying “influential rumormongers”. The method directs an advertisement to identified rumormongers with the assumption that they will disseminate the advertisement to others.

### SUMMARY OF THE INVENTION

According to one aspect of the invention there is provided a method of disseminating information by a first end terminal in a network having a plurality of end terminals. Said method includes receiving information from an information source, validating said information and storing said validated information. Said method also includes automatically forwarding said validated information to a second end terminal of said plurality of end terminals over a communication channel established between said first and said second end terminals. Said communication channel is established for a purpose separate from forwarding said validated information.

Preferably, said method further includes receiving a positive acknowledgement from said second end terminal.

Preferably, said method further includes informing said information source that said information has been successfully disseminated.

Preferably, said method further includes receiving a reward for successfully disseminating said information.

Suitably, validating said information may include validating said information using a verification key provided by a certification authority.

Preferably, said verification key should be a public key.

Suitably, said method may be performed by a validated first end terminal.

Suitably, said first end terminal may be validated using a root key.

Preferably, said information should be forwarded over said established communication channel as a piggyback in a frame.

Preferably, said information should be contained in a data field of said frame.

According to another aspect of the invention there is provided a method of disseminating information over a network having a plurality of end terminals. Said method includes sending information from an information source to at least one end terminal. Said at least one end terminal validates said information and forwards said information via a piggyback in a frame when a channel is established between said at least one end terminal and another end terminal for a purpose other than dissemination of information.

According to yet another aspect of the invention there is provided a system for disseminating information. Said system has an information source and at least two end terminals including a first end terminal and a second end terminal. Said first end terminal performs a method including receiving information from said information source, validating said information and storing said validated information. Said method also includes automatically forwarding said validated information to said second end terminal of said plurality of end terminals over a communication channel established between said first and said second end terminals. Said communication channel is established for a purpose separate from forwarding said validated information.

Suitably, said system further includes an information certification authority that provides a verification key to said first end terminal for validating said information.

Suitably, said information source receives said information from said information certification authority.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a block diagram showing an information dissemination system according to the present invention;

FIG. 2 is a sequence of steps for forwarding information by an end terminal in the system in FIG. 1; and

FIG. 3 is a sequence of steps for receiving information by an end terminal in the system in FIG. 1.

### DETAILED DESCRIPTION OF A PREFERRED EMBODIMENT OF THE INVENTION

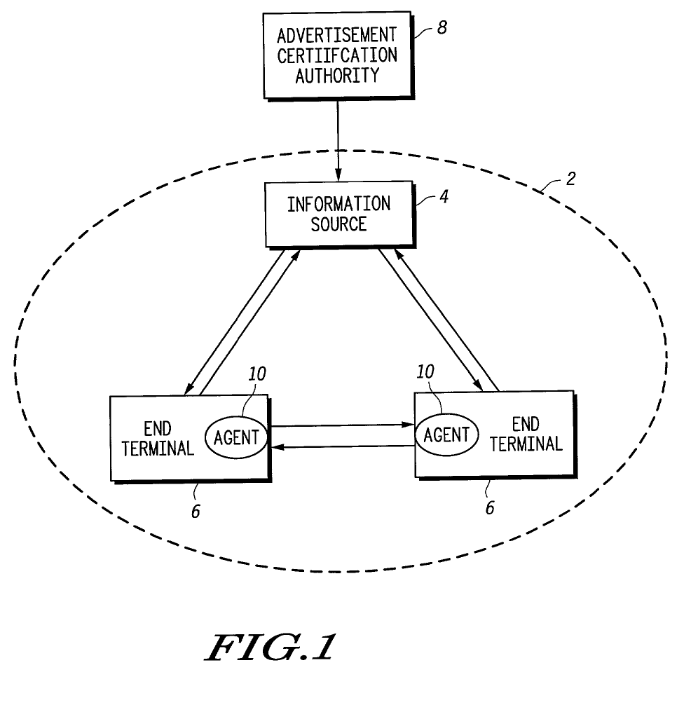

FIG. 1 shows an information dissemination system involving a network 2 having at least one information source 4 and a plurality of end terminals 6, only two of which are shown. The network 2 may be the Internet, a wireless Internet, a cellular phone network or the like. Correspondingly, the end terminals 4 may be client computers, personal digital assistants, cellular phones or other similar devices. The information source 4 may be a server in a client-server computing model to which client computers are connected. The information source 4 may also be a computer for hosting a Web site. The information source 4 contains advertising information or advertisements for dissemination. The advertisements may be a text file, an audio message, an image, an executable file or the like. An advertisement certification authority 8 provides the information source 4 with authorized advertisements for dissemination.

When an end terminal 6, such as a client, communicates with the information source 4, such as a server to request a service, the information source 4 sends the advertisements to the end terminal 6. For the case of a Web site host as an information source 4, the advertisements are sent to an end terminal 6 that logs onto the Web site. Other means of providing the advertisements to the end terminals 6 are possible. One example is to have the advertisements preloaded onto the end terminals 6 during manufacturing. The end terminals 6 render these advertisements to users of the end terminals 6 during appropriate operational states.

After the end terminal 6 receives the advertisements, it acts as a proxy of the information source 4 to further automatically disseminate the advertisements to other end terminals 6. The dissemination of the advertisements occurs when a communication channel is established between two end terminals 6 for separate purposes such as email communication, file transfer, etc. Such a mode of information dissemination is analogous to “word-of-mouth” information propagation.

An agent 10 developed to run on each end terminal 6 is responsible for handling advertisement-related activities. During power-up, the agent 10 is validated using a protected root key before the agent 10 is allowed to run. Such a validation process using cryptography is well known to those skilled in the art.

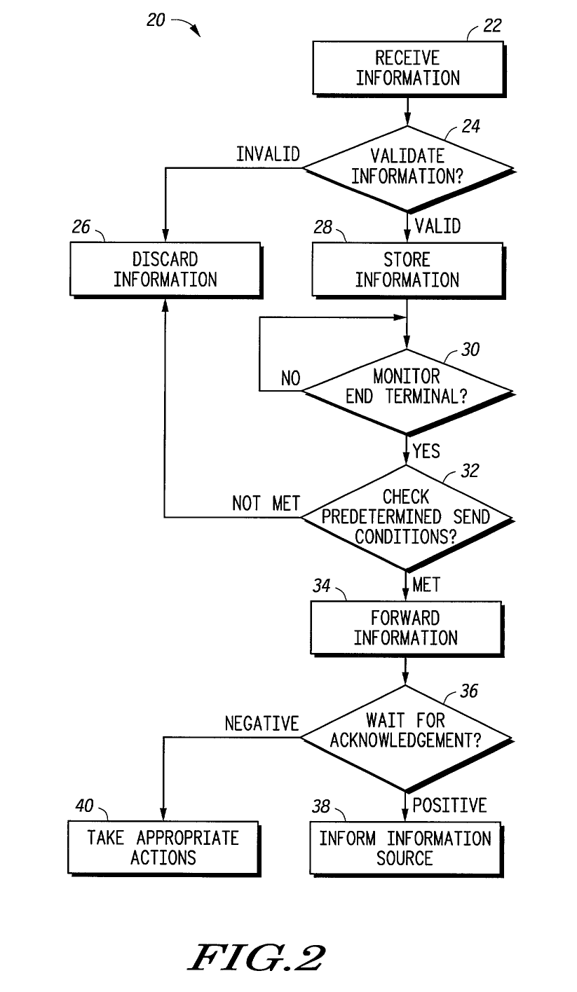

FIG. 2 shows a send sequence 20 of steps performed by the agent 10 on an originating end terminal 6. For simplicity, the agent 10 on the originating end terminal 6 is hereafter referred to as a sender. The send sequence 20 starts with a RECEIVE INFORMATION step 22, where the sender is provided with advertising information or an advertisement as previously described. The send sequence 20 next proceeds to a VALIDATE INFORMATION step 24, where the sender validates the advertisement using a verification key, such as a public key, obtained from the advertisement certification authority 8.

If it is determined in the VALIDATE INFORMATION step 24 that the advertisement is invalid, the send sequence 20 proceeds to a DISCARD INFORMATION step 26, where the sender discards the advertisement. If however the advertisement is determined to be valid, the send sequence 20 proceeds to a STORE INFORMATION step 28, where the sender stores the advertisement in a memory of the originating end terminal 6.

The send sequence 20 next proceeds to a MONITOR END TERMINAL step 30, where the sender monitors the originating end terminal 6 for an established communication session or channel between the originating end terminal 6 and a receiving end terminal 6. Either the originating end terminal 6 or the receiving end terminal 6 can establish the communication channel. As previously mentioned, the establishing of the channel is for a purpose separate from the exchange of advertisements between the two end terminals 6.

If it is determined in the MONITOR END TERMINAL step 30 that no communications channel has been established, the send sequence 20 loops around the MONITOR END TERMINAL step 30. If however it is determined that a communication channel has been established, the send sequence 20 proceeds to a CHECK PREDETERMINED SEND CONDITIONS step 32, where the sender checks predetermined conditions for forwarding the advertisement. Checking conditions includes checking an age of the advertisement, the number of times the advertisement has been forwarded or acknowledged to have been received, etc.

If it is determined that the conditions are appropriate, the send sequence 20 proceeds to a FORWARD INFORMATION step 34, where the sender forwards the advertisement to the receiving end terminal 6. It should be noted that more than one advertisement may be forwarded. In such a case, the rate and number of advertisements forwarded may be determined based on available bandwidth on the established channel, time of day, network load, advertisement type and age, etc.

The advertisement may be forwarded over the established channel as a piggyback, preferably in the data field of a frame following data for which the channel has been established. In addition to the advertisement, information such as advertisement type, advertisement length, etc. may be forwarded. Those skilled in the art will know that an advertisement may be divided into several portions for forwarding to the receiving end terminal over separate established communication sessions or channels. In such a case, the receiving end terminal 6 would have to assemble the different portions to form the complete advertisement.

The agent 10 interfaces with a protocol stack machine in each end terminal 6 for sending and receiving advertisements. For example, when the protocol stack machine receives a connection acknowledgement, it informs the agent 10 that a communication channel is established. The agent 10 also sends advertisements to the protocol stack machine for it to assemble into a data field for transmission.

If it is determined in the CHECK PREDETERMINED SEND CONDITIONS step 32 that the conditions are inappropriate, no action is taken to forward the advertising information. Instead, if the age of an advertisement is determined to have exceeded a predetermined threshold, the advertisement is discarded.

After the advertisements have been forwarded in the FORWARD INFORMATION step 34, the send sequence 20 proceeds to a WAIT FOR ACKNOWLEDGEMENT step 36, where the sender waits for an acknowledgement from the receiving end terminal 6. The acknowledgement can be either negative or positive. If a positive acknowledgement is received, the send sequence 20 proceeds to an INFORM INFORMATION SOURCE step 38, where the sender informs the information source 4 that an advertisement has been successfully forwarded. Depending on the business model for which the information dissemination system is used, the information source 4 may credit points to an account of the originating end terminal 6 as a reward for the successful forwarding of the advertisement. Such points may be used to defray a client's subscription fee, for the exchange of gifts, etc.

If a negative acknowledgement is received as determined in the WAIT FOR ACKNOWLEDEMENT step 36, the send sequence 20 proceeds to a TAKE APPROPRIATE ACTION step 40, where the sender takes an appropriate action such as discarding an advertisement if acknowledgements for that advertisement have been consistently negative.

It should be noted that for simplicity sake, the steps in the send sequence 20 are shown to be sequential. Those skilled in the art would recognize that multitasking of some of the steps is more appropriate for implementing the system. Further, it will be understood that the agent 10 continues to loop at step 30 as long as it is operable so that information is forwarded to other end terminals 6 as connections to such end terminals 6 are established.

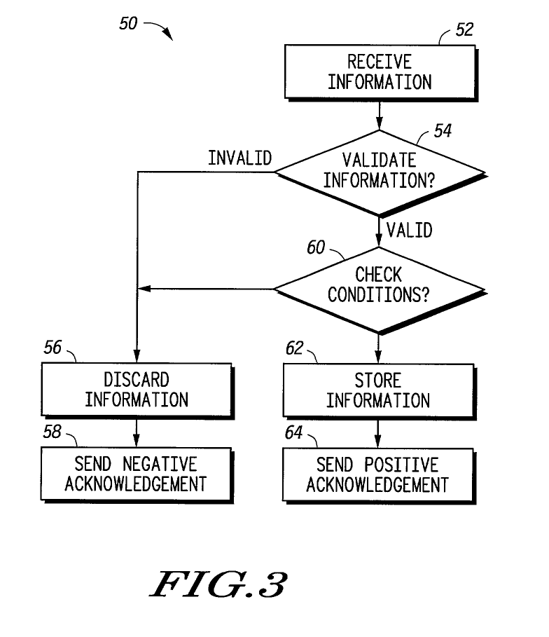

FIG. 3 shows a receipt sequence 50 of steps performed by the agent 10 on the receiving end terminal 6, hereafter referred to as a receiver. The receipt sequence 50 starts with a RECEIVE INFORMATION step 52 when the sender forwards the advertisement to the receiver. The receipt sequence 50 proceeds to a VALIDATE INFORMATION step 54, where the receiver validates the advertisement. If it is determined that the advertisement is invalid, the receiver discards the advertisement and sends a negative acknowledgement in a DISCARD INFORMATION step 56 and a SEND NEGATIVE ACKNOWLEDGEMENT step 58. If however it is determined that the advertisement is valid, the receipt sequence 50 proceeds to a CHECK CONDITIONS step 60, where the receiver checks conditions for the receipt of a valid advertisement. The conditions may include whether the same advertisement has been previously received and if there is sufficient memory to store the advertisement, etc. Other conditions may be established depending on the business model, as will be understood by those skilled in the art.

If conditions are inappropriate as determined in the CHECK CONDITIONS step 60, the receipt sequence 50 proceeds to the DISCARD INFORMATION step 56, where the receiver discards the advertisment. Thereafter, the receipt sequence 50 proceeds to the SEND NEGATIVE ACKNOWLEDGEMENT step 58, where the receiver sends a negative acknowledgement to the sender. If however the conditions are appropriate for the receipt of the advertisement, the receipt sequence 50 proceeds to a STORE INFORMATION step 62, where the receiver stores the advertisement for subsequent rendering by the receiving end terminal 6. Of course, the advertisement may be immediately rendered. The receipt sequence 50 next proceeds to a SEND POSITIVE ACKNOWLEDGEMENT step 64, where the receiver sends a confirmation or positive acknowledgement to the sender.

It is to be recognized that the send and receipt sequences 20, 50 are both implemented on each end terminal 6. After receiving an advertisement, the receiver in turn is able to forward the advertisement to another end terminal using the send sequence 20.

Advantageously, the method of disseminating advertising information is potentially able to reach a wider audience compared to existing methods involving only dissemination of information by centralized information sources. The opportunities for dissemination of information in the system is increased vastly by allowing end terminals to act as proxies for disseminating information. With the convergence of the cellular phone network and the World Wide Web, such a method will potentially have wider reach to end terminals that includes cellular phones, personal computers, personal digital assistants and other similar devices.

Although the invention has been described with reference to the preferred embodiment, it is to be understood that the invention is not restricted to the embodiment described herein. For example, forwarding of advertisements may be bi-directional over an established channel.

We claim:

1. A method of disseminating information by a first end terminal in a network having a plurality of end terminals, said method comprising:
receiving information from an information source;
validating said information;
storing said validated information; and
automatically forwarding said validated information to a second end terminal of said plurality of end terminals over a communication channel established between said first and said second end terminals, wherein said communication channel is established for a purpose separate from forwarding said validated information.

2. A method according to claim 1, further including receiving a positive acknowledgement from said second end terminal.

3. A method according to claim 2, further including informing said information source that said information has been successfully disseminated.

4. A method according to claim 3, further including receiving a reward for successfully disseminating said information.

5. A method according to claim 1, wherein validating said information includes validating said information using a verification key provided by a certification authority.

6. A method according to claim 5, wherein said verification key is a public key.

7. A method according to claim 1, wherein said method is performed by a validated first end terminal.

8. A method according to claim 7, wherein said first end terminal is validated using a root key.

9. A method according to claim 1, wherein said information is forwarded over said established communication channel as a piggyback in a frame.

10. A method according to claim 9, wherein said information is contained in a data field of said frame.

11. A method of disseminating information by a first end terminal in a network having a plurality of end terminals, said method comprising:
receiving information from an information source;
validating said information;
storing said-validated information;
detecting establishment of a communication channel between said first end terminal and a second end terminal of said plurality of end terminals, wherein said communication channel is established for a purpose separate from forwarding said validated information; and
automatically forwarding validated information to said second end terminal over said established communication channel.

12. A method according to claim 11, further comprising:
receiving a positive acknowledgement from said second end terminal; and
informing said information source that said information is successfully disseminated.

13. A method according to claim 12, further comprising:
receiving a reward for successfully disseminating said information.

14. A method of disseminating information over a network having a plurality of end terminals, said method comprising:
sending information from an information source to at least one end terminal, wherein said at least one end terminal validates said information and forwards said information via a piggyback in a frame when a channel is established between said at least one end terminal and another end terminal for a purpose other than dissemination of information.

15. A system for disseminating information comprising:
an information source; and
at least two end terminals including a first end terminal and a second end terminal;
wherein said first end terminal performs a method including:
receiving information from said information source;
validating said information;
storing said validated information; and
automatically forwarding said validated information to said second end terminal of said plurality of end terminals over a communication channel established between said first and said second end terminals, wherein said communication channel is established for a purpose separate from forwarding said validated information.

16. A system according to claim 15, further including an information certification authority that provides a verification key to said first end terminal for validating said information.

17. A system according to claim 16, wherein said information source receives said information from said information certification authority.
